(19) United States
(12) Patent Application Publication
(10) Pub. No.: US 2025/0077259 A1
(43) Pub. Date: Mar. 6, 2025

(54) Security-Preserving Generation and Performance of Cloud Actions

(71) Applicant: ServiceNow, Inc., Santa Clara, CA (US)

(72) Inventors: Ganesh Parameshwar Bhat, Bangalore (IN); Ramkumar Devanathan, Bangalore (IN)

(21) Appl. No.: 18/461,865

(22) Filed: Sep. 6, 2023

(51) Int. Cl. G06F 9/455

(52) U.S. Cl. CPC G06F 9/45558; G06F 2009/45562

(57) ABSTRACT

Methods are provided for leveraging generative artificial intelligence to generate commands and other aspects of modification actions that can be used by users to create, delete, and/or modify virtual machines in a cloud computing environment or to interact with aspects of some other computing environment. The generation and execution of such modification actions can implicate extensive computational and other requirements and may also require the performance of multiple tasks requiring differing levels of access credential. For example, updating a database to reflect changes made to a computing environment by execution of a modification action may require a higher level of credential than performing the changes themselves. The action generation and execution methods described herein allow users with such lower-level credentials to enact such changes while also performing associated database updates or other higher-credential actions.

### BACKGROUND

A variety of information technology services and processes can be accomplished in a scalable, efficient, and low-cost manner using commercially-available cloud services. However, to interact with such services, a user must consult the application programming interface (API) documentation, command line interface (CLI) documentation, or other information made available about the operation of such services in order to generate properly-formatted API calls, command line commands, or other commands to implement the user's intended interactions (e.g., delete a virtual machine, modify parameters of a virtual machine, instantiate a new virtual machine).

When a new cloud service or feature thereof becomes available, it can be beneficial to develop tools (e.g., applications or plugins) to allow users to interact with the features of the cloud service. For example, to allow a user to easily start, stop, or modify specific virtual machines or sets of virtual machines within a cloud environment. However, developing these tools can be resource intensive, requiring significant development and testing utilizing processing, memory, and network resources. For example, it is resource intensive to design a tool, verify that the tool is functional, and that it satisfies security-based constraints. This can lead to a significant delay between the time at which development of such a tool begins and when the tool become available for use.

### SUMMARY

A generative artificial intelligence or other natural language model can be employed to use cloud service documentation to generate cloud modification actions, thereby significantly reducing or even eliminating developer time needed to generate such actions such as API calls or command line commands. However, such automated generation may implicate security permissions or other credential requirements related to the performance of various tasks (e.g., sending commands to cloud servers, updating configuration management databases (CMDBs) or other databases) in a manner that cannot or should not be approved and/or implemented by the same devices or entities that are likely to execute or otherwise use such actions.

The embodiments described herein leverage prompt engineering and other techniques to generate, in an automated fashion, actions for a cloud computing system or other information technology system. These actions can include commands (e.g., to start, stop, create, modify, or otherwise interact with virtual machines in a cloud computing environment) and database updates based on the results of execution of such commands (e.g., to update a representation of the size of a particular virtual machine in a CMDB following successful modification of the size of the virtual machine as a result of the execution of the command). The level of access (e.g., type or level of security credential) necessary to perform a command may differ from the level of access necessary to perform the database update. Accordingly, the performance of the action can require a credential that is sufficient to perform the management action (e.g., to manipulate one or more virtual machines) but that is not necessarily sufficient to perform the database update(s) that may also result from performance of the management action.

Accordingly, a first example embodiment may involve a method that includes: (i) applying an input to a natural language model to generate a modification action, wherein the modification action includes a command and a database update, and wherein the database update is associated with a parameter of a computing system; (ii) determining that user credential data satisfies an update condition with respect to the command; (iii) in response to determining satisfaction of the update condition, transmitting the command to the computing system, and receiving, from the computing system, a value for the parameter; and (iv) updating the parameter of a database based on the value.

A second example embodiment may involve a non-transitory computer-readable medium, having stored thereon program instructions that, upon execution by a computing system, cause the computing system to perform operations in accordance with the first example embodiment.

In a third example embodiment, a computing system may include at least one processor, as well as memory and program instructions. The program instructions may be stored in the memory, and upon execution by the at least one processor, cause the computing system to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 illustrates elements of computing systems in communication with each other, in accordance with example embodiments.

FIG. 7A illustrates aspects of a user interface, in accordance with example embodiments.

FIG. 7B illustrates aspects of a user interface, in accordance with example embodiments.

FIG. 7C illustrates aspects of a user interface, in accordance with example embodiments.

FIG. 7D illustrates aspects of a user interface, in accordance with example embodiments.

FIG. 8 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

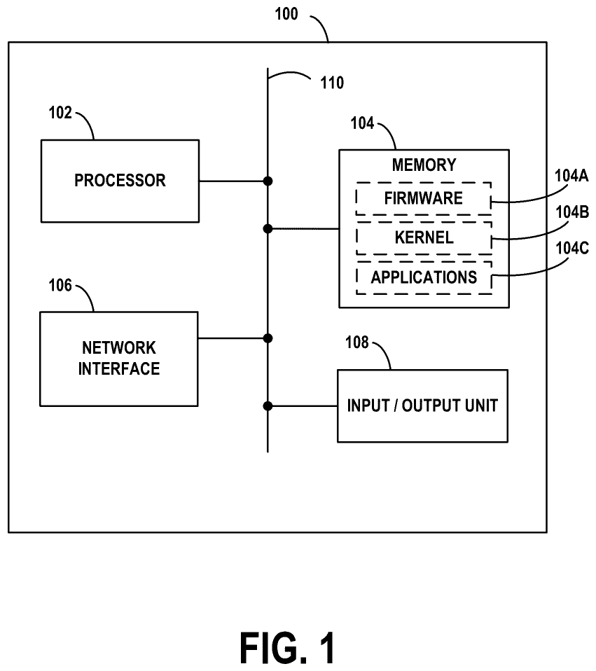

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

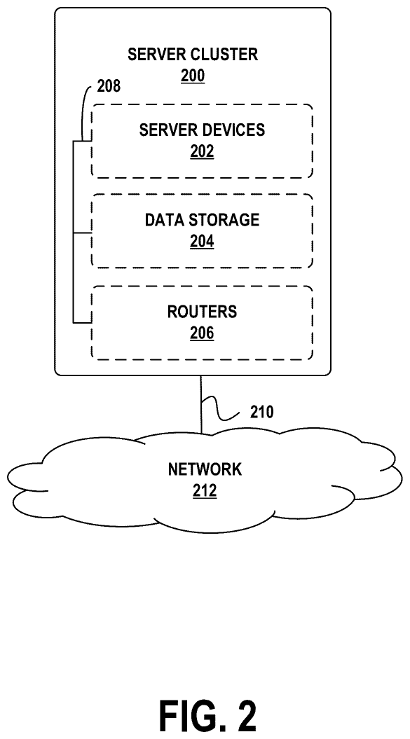

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the extensible Markup Language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

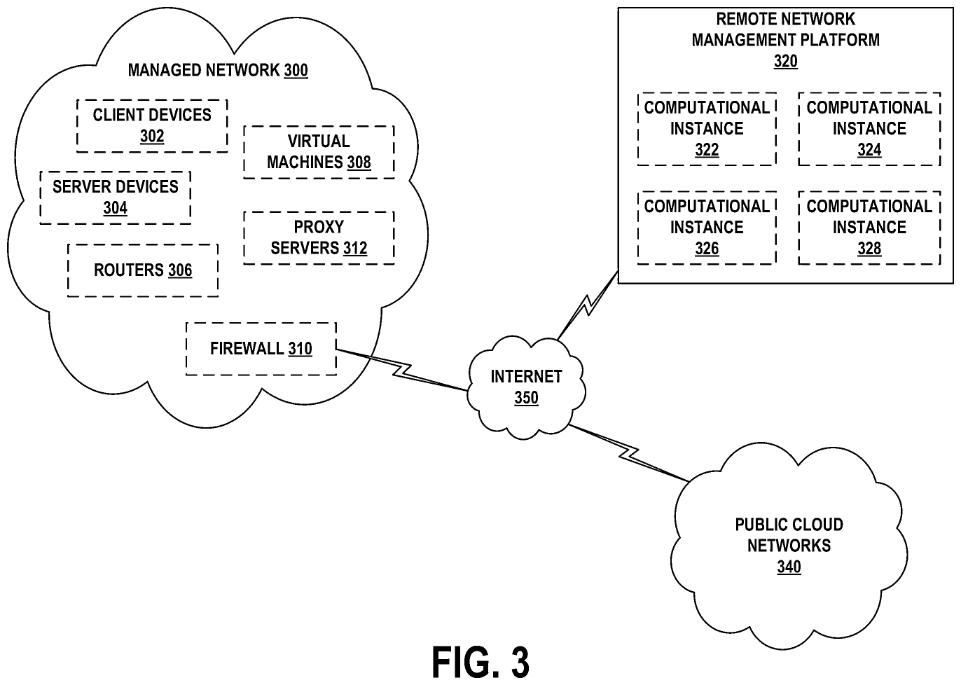

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well- defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

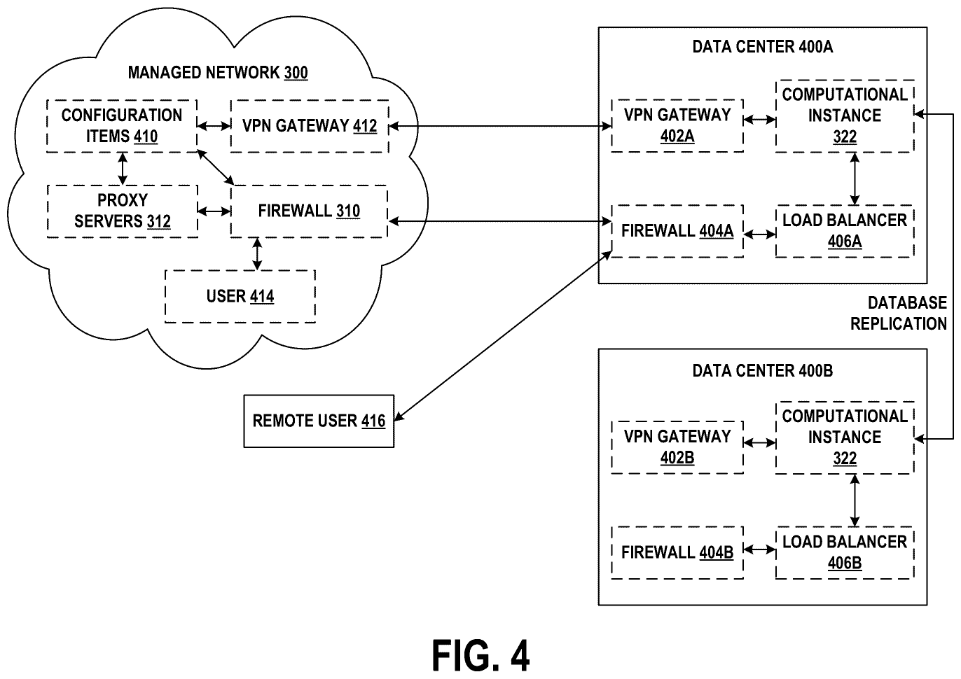

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of each device, component, application, and service may be referred to as a configuration item. The process of determining the configuration items and relationships within managed network 300 is referred to as discovery, and may be facilitated at least in part by proxy servers 312. Representations of configuration items and relationships are stored in a CMDB.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

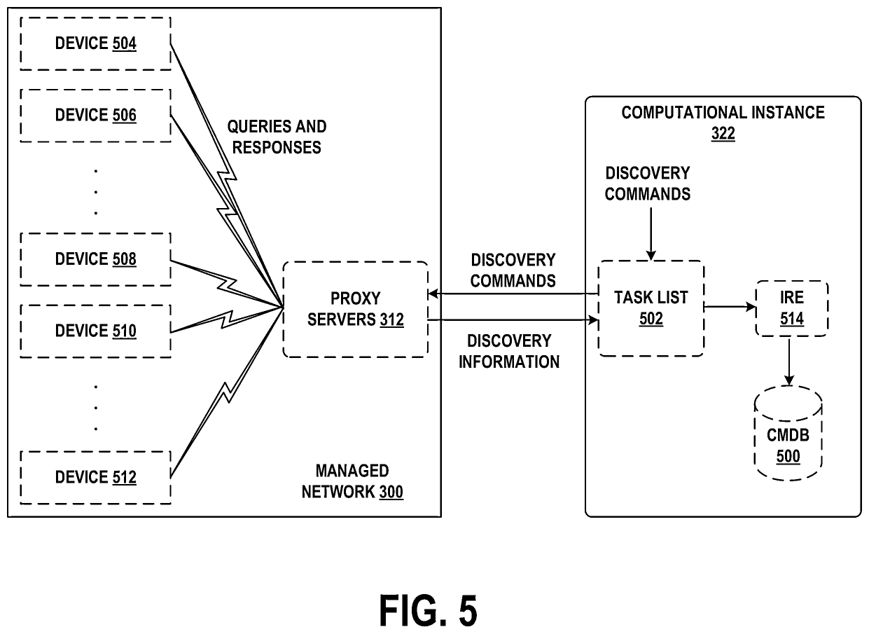

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top- down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases—under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Example Generation of Cloud Actions and Performance of Generated Cloud Actions

It is beneficial to generate easy-to-use automated actions to accomplish various common tasks related to interaction with a cloud computing environment, platform-as-a-service (PaaS) environment (e.g., with apps, functions, macro-services, or other functionality made available), or other remote computing environment. Such tasks can include starting, stopping, modifying, deleting, or otherwise interacting with virtual machines in the cloud computing environment, manipulating disks of the cloud environment, their contents, and/or their association with virtual machines, passing inputs to and/or receiving outputs from functions of a PaaS environment, executing or otherwise interacting with apps provided by a PaaS environment, or other tasks. Providing easy-to-use automated “modification actions” for such tasks reduces the effort needed to perform the modification actions (e.g., relative to consulting documentation and forming an API call, command line command, or other command manually), reduces errors, and allows the results of the modification actions to be automatically ingested into a CMDB or other database used to reflect the configuration of the cloud computing, PaaS, or other computing environment. Additionally, such automated modification actions allow users without the skills to manually generate API calls, command line command, or otherwise implement such cloud, PaaS, or other actions to obtain the effects of the desired actions despite lacking those skills.

Such modification actions can include human-readable descriptions of the effect and consequences of the modification action, parameters or other inputs to the modification action (e.g., a size of memory to change a virtual machine to, an identity of a virtual machine to delete/modify), a URL or other code describing a destination and contents of an API call or command line command output from the modification action to implement the modification action, code or other information defining updates to a CMDB to perform in response to the performance of the modification action, or other information defining the modification action. Such a modification action can be generated manually by human developers. However, generation by human developers can be time-consuming and costly. This can lead to backlogs between the time at which a user experiences a need for such a modification action, and the time at which the user is able to use the modification action following development, validation, and approval. Additionally, the development of such modification actions (e.g., test use of a modification action under development) may include the use of private user data which may not be readily available to a developer and/or that a user may not wish to have exposed publicly. Yet further, development of such modification actions can require significant computational resources in order to perform the end-to-end governance, inspection, and approval processes necessary to put the modification action into effect in a production context.

Accordingly, the systems and methods described herein leverage generative artificial intelligence (GenAI) models to automatically generate the contents of such automated modification actions based on publicly-available API or command line interface documentation or other public information about the operation of cloud, PaaS, or other computing environments. This public data is ingested into a private environment (e.g., a management server of a CMDB) that can be used by developers and/or users to approve the modification actions generated by the GenAI models or to otherwise influence or manage such generation. This type of operation also provides enhanced security of private user data, as those portions of the modification action development that include private user data can be performed internally, in the private environment. Operations that involve transmission of data publicly (e.g., calls to a publicly-hosted GenAI model) can be limited to the use of non-private data only.

GenAI-generated modification actions can then be quickly and easily subjected to review, modification, and/or approval by developers, compliance officers, service managers, or other individuals in order to make the modification actions available for use by end-users. The use of GenAI to generate the modification actions, and the use of automated systems to present the modification actions to developers and others for review, modification, and/or approval can reduce the time between a user requesting a particular modification action and that modification action being made available to the user in a production environment. This can also reduce the memory and communications bandwidth requirements needed to facilitate such review, modification, and/or approval since only those elements of the modification action that are relevant to a particular person (e.g., the complete modification action to a developer, only the description and necessary permissions to a compliance officer) need be presented to the particular person for review, modification, and/or approval.

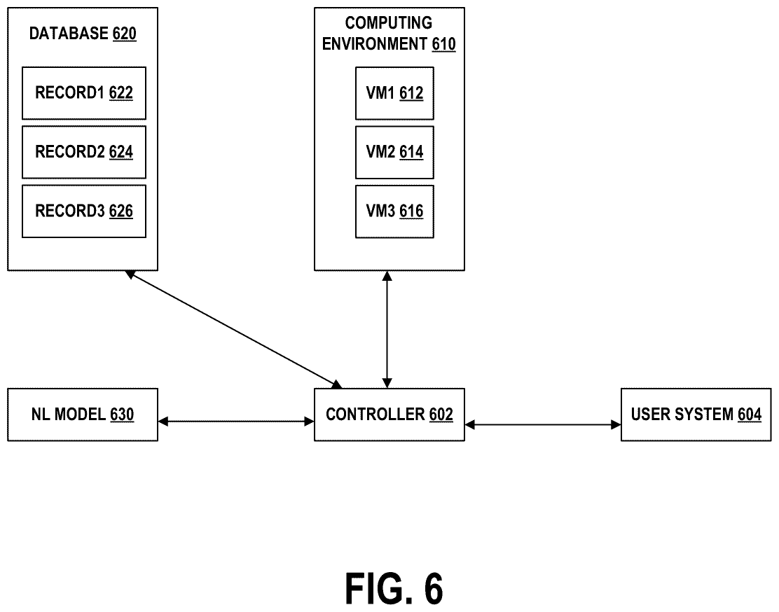

FIG. 6 depicts, by way of example, aspects of a system that may implement the methods described herein. A controller 602 is in communication with a remote computing environment 610 (e.g., a cloud computing environment, a server running one or more virtual machines, a server or other system implementing a PaaS, or some other remote system) that is running a number of virtual machines (“VM1 . . . 2 . . . 3”) 612, 614, 616, a database 620 that contains records (“RECORD1 . . . 2 . . . 3”) 622, 624, 626 that describe the configuration of the virtual machines 612, 614, 616, a server or other computing system running a Generated AI or other natural language model (“NL model”) 630 that can be used to generate modification actions, and a user system 604 (e.g., a laptop, a desktop computer, a thin client, a cellphone) via which a user may interact with the controller 602.

Note that, while the controller 602, database 620, and user system 604 are depicted as separate systems in FIG. 6, they may be implemented as two or fewer systems (e.g., all three implements by a single server, the controller 602 and database 620 implemented by a single server). Further, the controller 602, database 620, and user system 604 may be collocated (e.g., implemented by one or more systems located in a single room, at a single site, connected to a single network) and/or part of a single virtual network (e.g., one or more of the systems could be connected to a common network via VPN).

To initially generate a modification action, the controller 602 sends an input (e.g., one or more prompts) to the NL model 630 and responsively receives therefrom a representation of the modification action. In order to preserve the privacy and security of the data in the database 620, the controller 602 may use only publicly available information (e.g., information from publicly available cloud, PaaS, or other environment documentation) to generate the prompt(s) or other inputs provided to the NL model 630. This can be beneficial in examples where the NL model 630 is hosted on and/or executed by servers or other computing systems provided by third parties, e.g., by generative AI organizations that provide interfaces (e.g., APIs, web-based interfaces, command line interfaces) for users to present inputs to large language models or other generative AI models and to receive outputs generated therefrom.

Executing such generative AI models or other NL models 630 can involve significant computational costs with respect to memory, computational cycles, bandwidth between compute nodes, and other computational requirements. Accordingly, it can be beneficial to separate the modification action generation process into the NL model 630, which executes a model to initially generate the modification action and which may be operated by a third party making the model generally available for such tasks, and the controller 602, which generates the initial input (e.g., prompts) and then handles downstream validation and approval of the modification action, as well as subsequent execution of the modification action. For example, this can allow the controller 602 to be sized or otherwise configured (e.g., with respect to amounts of memory, processors, communications bandwidth with other systems) to handle a relatively lower, more continuous level of activity to interact with users (via, e.g., user system 604), database 620, and computing environment 610 to implement user commands and to carry out other aspects of the operation of a remotely managed network or other information system. This is possible because the controller 602 does not need to be capable of executing the NL model 630, since that model is executed by a separate system 630 in communication with the controller 602. Instead, the controller 602 only needs to be capable of generating the prompts or other input to the NL model 630, transmitting that input to the NL model 630, receiving the modification action from the NL model 630, and then performing downstream tasks on the modification action (e.g., review, modification, approval, execution in a production environment).

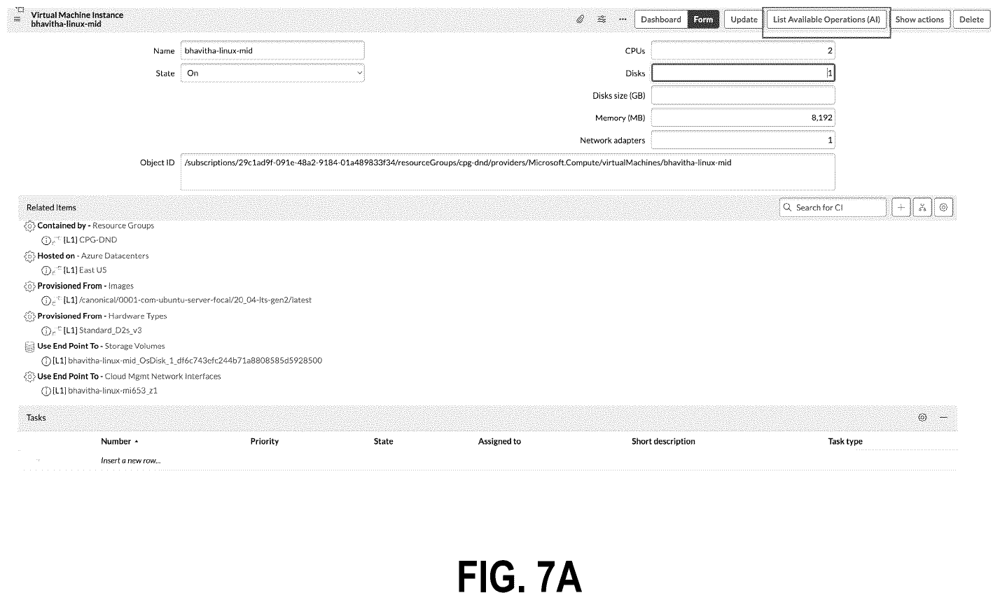

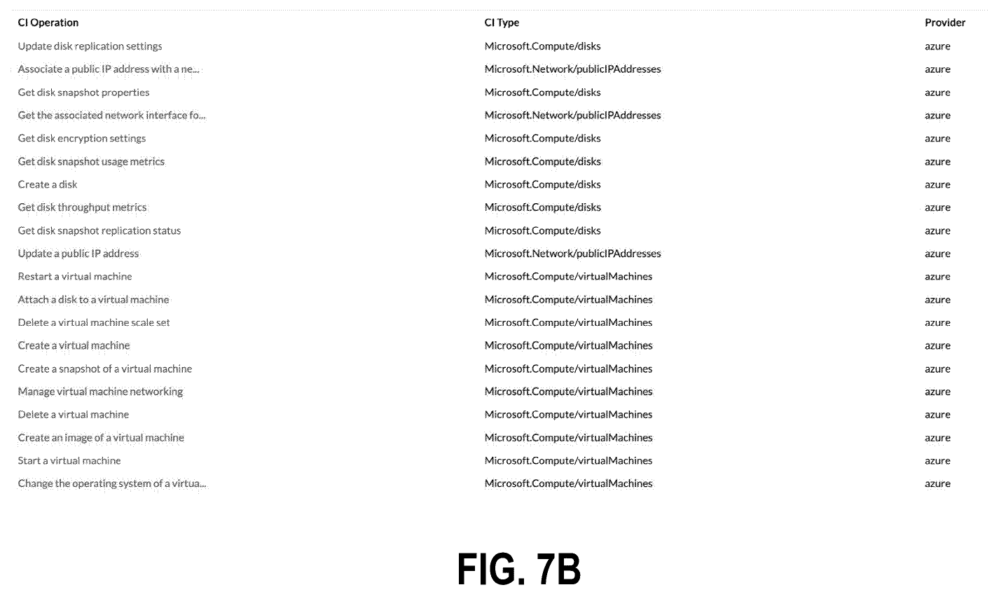

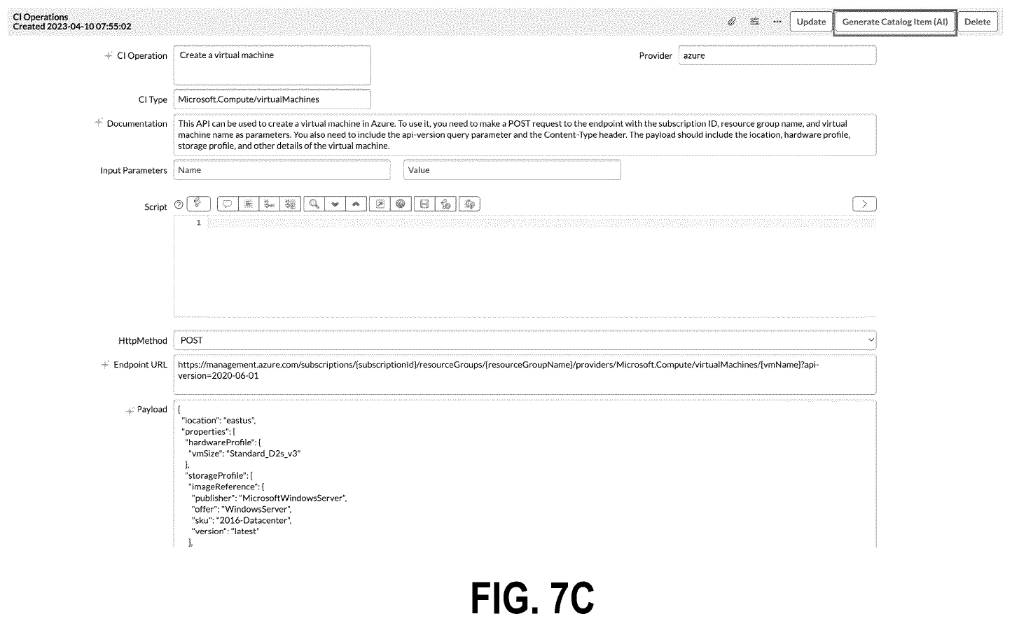

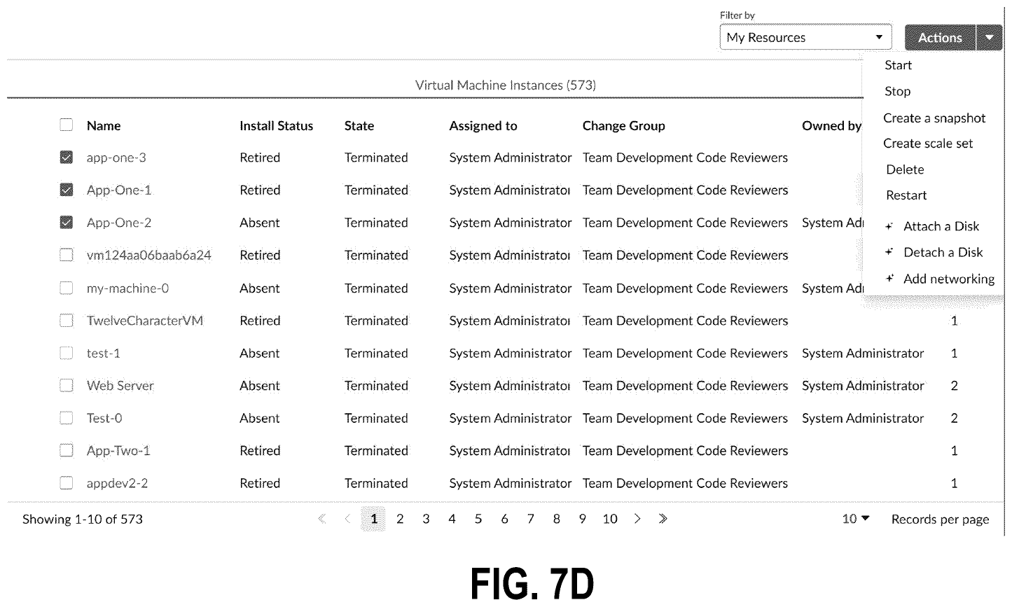

The modification action can be generated by applying a variety of inputs (e.g., one or more textual, natural language prompts) to the NL model 630. In some examples, the input could be applied to the NL model 630 as two or more prompts applied in sequence, with later prompt(s) being generated in part using information from prior prompt(s). For example, a first prompt could be a natural language request for the NL model 630 to generate a list of names of possible modification actions that could be performed on a specified cloud, PaaS, or other variety of computing environment (e.g., “Generate a list of modification actions that can be performed on a Microsoft Azure cloud computing environment.”). The output of the NL model 630 could then be parsed or otherwise processed to extract the names of potential modification actions. The leftmost column of FIG. 7B depicts an example of the names of modification actions that could be returned in response to such a prompt. In some examples, the prompt could specify a formatting (e.g., “Generate a list of modification actions . . . as a comma separated list.”) in order to simplify the extraction of individual modification action names from the output of the model and/or to reduce the likelihood of the output being incorrectly parsed.

A second prompt could then be generated, including one of the modification action names returned in response to the first prompt, to generate a modification action (e.g., “Generate an “Update disk replication settings” modification action.”). The prompt could include additional content, e.g., an identification of the type of cloud, PaaS, or other computing environment for which the modification action is to be generated (e.g., “Generate an “Update disk replication settings” modification action for a Microsoft Azure cloud computing environment.”), formatting information for the returned modification action (e.g., “Generate JSON code specifying an “. . . ” modification action . . . ”), information specifying the particular contents of the returned modification action (e.g., “Generate an endpoint URL, payload, and English summary for an “. . . ” modification action . . . ”), or some other information. In some examples, the first, second, and/or additional prompts could include content in common, e.g., to encourage the NL model to provide outputs of a desired quality or type. For example, the first, second, and/or additional prompts could all include common text instructing the model to produce output as though generated by a skilled developer (e.g., “Generate . . . as though you were a skilled Microsoft Azure developer.”).

The model output, representing the contents of a modification action, can then be ingested by the controller 602 (e.g., recorded in a database entry for later retrieval and use). This could include parsing the returned information or other post-processing, e.g., to determine different aspects of the returned information (e.g., a URL to which to send a command when executing the modification action) and what further information is needed (e.g., input parameters for one or more commands of the modification action, such inputs to be obtained from user input and/or from a database) in order to execute the modification action. For example, for a URL of the modification action to which to send a command when executing the modification action, it could be determined which portions of the URL require information (e.g., from user input, from a database) like a subscriber ID needed to be inserted in order for a cloud, PaaS, or other computing environment to accept the command or an object ID needed to be inserted into in order to identify which virtual machine to modify. In another example, a memory size needed to specify the updated memory of a virtual machine, a type and configuration of a to-be-created virtual machine, an object ID of a to-be-deleted virtual machine, or some other information could be determined as needed to be inserted into a payload that will be sent to a cloud, PaaS, or other computing environment in order to implement a modification action.

The prompts or other inputs could be applied to the NL model 630 to generate modification action(s) in response to a user request to do so. This could be done, e.g., in response to a developer or other user noting that a new cloud, PaaS, or other computing environment, or version thereof, has become available and in response commanding the controller 602 to engage in the methods described herein. In some examples, a user could interact with a virtual agent (e.g., a virtual agent whose responses are fully or partially generated by a generative AI or another natural language model). In such examples, the user's text, obtained via the virtual agent dialog, could be determined to represent a request to generate one or more modification actions. The prompts or other inputs could then be applied to the NL model 630 responsive to determining that the user text inputs represented such a request.

FIG. 7C illustrates a user interface showing various aspects of a modification action as generated by a natural language model. As shown, the modification action includes a name (“Create a virtual machine,” which may be a name output as part of a list of names returned in response to a first prompt to generate a list of such modification action names), a type of the modification action, a human-readable summary of the modification action, a method for executing the action, a URL to which to send information to implement the modification action, and a payload of information to be sent to the URL. In this example, the URL and payload may be referred to as a ‘command,’ which can be sent to a cloud, PaaS, or other type of computing environment in order to cause the computing environment to implement the modification action. The modification action can also include a ‘database update’ that represents information in a database (e.g., tables, parameters, values) to be updated based on the result of sending the command. For example, where the command is a command to create a new virtual machine, the database update could include an object ID and/or addressing information to allow the new virtual machine to be addressed or otherwise interacted with in the future, information about the configuration or status of the newly created virtual machine (e.g., a size of memory, an ID of a hard disk or other memory to which the machine has access), or other information about the newly created virtual machine and/or about the specifics of implementation of the command.

Note that the user interface shown in FIG. 7C could be used, by a developer or other person, to edit the contents of the modification action (e.g., to correct errors, to remove unwanted aspects of the modification action), approve the modification action (e.g., to add the modification action to a catalog of such modification actions for selection and use by downstream users), or to take some other action related to the modification action.

The methods and systems described herein (e.g., the distribution of tasks described with reference to FIG. 6) can provide a variety of benefits with respect to privacy and security. A database (like the database 620 of FIG. 6) can contain significant private information about the configuration and operation of an information technology system, including information about how to access and control aspects of that system (e.g., virtual machines) that are hosted ‘externally’ in a cloud computing environment, PaaS, or other remote computing environment provided by a third party to many other organizations or systems. Such information may be required to control elements of a cloud, PaaS, or other type of remote computing environment (e.g., subscriber IDs, object IDs, configuration data, license data) and/or to facilitate a user managing such control. It would be beneficial to reduce the amount of such information that is exposed publicly (e.g., by being transmitted over the internet or some other public network). The controller 602 can be collocated with, hosted on the same server as, or otherwise in secure privileged communication with the database 620 such that, while the controller 602 has access to the entire set of secure, private information in the database 620, the controller 602 only transmits what secure, private information is necessary to implement a user's execution of various modification actions.

This can include the controller 602 only providing a user system 604 with a list of virtual machines that match some user-specified criteria (e.g., that have out-of-date software and that thus could be updated by one or more modification actions), rather than providing the user system 604 with a list of all available systems and their criteria-relevant properties. When a user selects a modification action to perform, the controller 602 can then access the specific data necessary to execute the modification action from the database 620 (e.g., from the RECORD relevant to a virtual machine to be modified thereby) and use that information to generate a command (e.g., a subscriber ID, an object ID) that is then transmitted to the computing environment 610 without also transmitting that information to the user system 604. Further, the controller's 602 connection with the computing environment 610 may be especially secure (e.g., an end-to-end encrypted channel, a dedicated hardware connection, MAC and/or IP filtering on both ends), in order to secure what private information may be present in the command of the modification action. Relatively less private information may be provided, via a relatively less secure communications channel, to the user system 604 to enable a user thereof to manage the execution of such modification actions (e.g., only a list of virtual machines and minimal information about their configuration, while the commands include object IDs, full configuration states, license data, subscriber IDs, or other information necessary to implement the command(s) of modification action(s) selected by the user).

Once a modification action has been generated by the NL model 630 it can be subjected to review and approval by developers or other individuals. For example, one or more developers could review, optionally modify, and then approve a modification action as being functional. Additional individuals (e.g., administrators) could then, in parallel or subsequent to the developer approval, approve the modification action for use. Then, compliance officers, managers, sales personnel, or other individuals could review and approve the modification action. The review process could be performed on a per-system and/or per-organization basis. For example, a modification action could be approved to the point that it is added to a ‘catalog’ of available actions. At that point, individual organizations could select/deselect the modification action (from the catalog) for use within their particular organization.

Once a modification action has been fully approved, it can be made available to individual users in order to modify aspects of a cloud, PaaS, or other type of remote computing environment (e.g., to start, stop, create, delete, modify, or otherwise interact with virtual machines of a cloud computing environment). FIG. 7D shows a user interface that a user could interact with in order to execute such modification actions. As shown in FIG. 7D, the user can select a subset of virtual machines (e.g., “app-one-3”) on which a selected modification action (e.g., “Start,” “Stop,” Attach a Disk ”) may be performed. Once the user has indicated that such a modification should be performed, the controller 602 can then formulate and send a command of the modification action to the computing environment 610 to execute the selected modification action.

Once the command has been sent to the computing environment 610, the computing environment 610 can then send a response to the controller 602 indicating the result of the command. This could include, e.g., an indication that the command failed and that there has been no change in the configuration of the virtual machines or other aspects of the computing environment 610. Alternatively, the command could wholly or partially succeed, resulting in changes to one or more aspects of the computing environment 610. In such a scenario, the computing environment 610 could send an updated value for one or more parameters to the controller 602 that are associated with a database update of the modification action. For example, if the modification action is to change a memory allocation of a virtual machine, the command of the modification action could be a command to set the memory allocation of the virtual machine to a user-specified value, and the database update could be associated with the updated memory allocation of the virtual machine as reported by the computing system 610 following implementation of the command.

It is beneficial for the controller 602 to update the relevant parameter(s) of the database 620 based on such received value(s) from the computing environment 610. FIG. 7A illustrates a number of such parameters (e.g., number of CPUs “CPUs,” number of disks attached “Disks,” the amount of allocated memory “Memory (MB),” object ID string, information about related items) of an example database record that corresponds to a particular virtual machine (“bhavitha-linux-mid”) as displayed in a user interface that also permits some of those parameters to be modified. However, it is also desirable that the permissions for changing, or even for viewing, such parameters are not available to all users, including many users who might need to interact with the computing system 610 using modification action(s).

To account for this, a particular modification action may be associated with two permission levels or other type of user credential information. A first permission level or user credential information could be required to execute the modification action, e.g., to create a new virtual machine. The modification action could also be associated with a second permission level or user credential information that is sufficient to update database parameters associated with the action taken by the modification action, e.g., object IDs, configuration data, or other database parameters relating to a new virtual machine created by the execution of the modification action. The level of permission or user credential information sufficient to update the database parameter(s) may also be sufficient to execute the modification action.

The user credential data or other permission required to update the associated database parameter may be provided during the development or approval of the modification action. For example, to fully approve a given modification action, a user may provide user credential data sufficient to modify all of the database parameter(s) associated with the database update of the modification action. In some examples, the approval process may include multiple users providing respective different user credential data that, in combination, are sufficient to update all of the parameters whose updating is implicated by the execution of the modification action. Indeed, the modification action approval process could proceed in an automated or semi-automated fashion by only seeking approval from users (e.g., on an ordered list of modification action-approving users) whose permissions are still needed to modify parameter(s) of the modification action's database update for which permissions have not yet been granted. In this way, the number of users polled for such user credential information, and the associated computing time and communications bandwidth associated with obtaining such credential information, can be reduced.

### VII. Example Technical Improvements

These embodiments described herein provide technical solutions to technical problems. One technical problem being solved is the time and latency involved in generating modification actions for interacting with a cloud computing environment, PaaS, or other computing environment. In practice, this is problematic because, since developers and a variety of other individuals are involved in the process of creating, reviewing, and approving modification actions in response to a user request therefore, there can be a great amount of time between the user's request and the satisfaction of that request with a fully developed and approved modification action. The embodiments described herein significantly reduce that latency by, among other things, using natural language models to generate the modification actions (and, in some examples, to initiate such generation based on user text inputs in virtual agent dialogs) and then simplifying the approval process of the generated modification action.

Another technical problem solved by the embodiments described herein is reducing the computational requirements of a controller used to obtain and implement modification actions generated by generative AI models or other natural language models. Executing a natural language model capable of generating modification actions as described herein can involve significant amounts of memory, processors, interconnect bandwidth, storage, or other computational resources. The embodiments herein use a first controller or other computing system that is separate from a second computing system used to execute the natural language model to generate prompts that are input to the second computing system to generate the modification actions using the natural language model. The first controller then receives the generated output and implements the approval and subsequent execution of the modification action. Accordingly, the first controller can be implemented in a relatively less computationally expensive manner, since it does not need to be capable of executing the natural language model.

Yet another technical problem solved by the embodiments described herein is securing private data that may be transmitted over the internet or other communications networks to third-party systems as part of interacting with such third-party systems to obtain the benefits of cloud, PaaS, or other types of computing systems provided by those third-party systems. In practice, databases used to record the ongoing operations and configuration of an information system, which may include virtual machine or other aspects implemented by a third-party cloud, PaaS, or other type of computing system, contain large amounts of private data that must be secured against access or modification by unauthorized users. However, to interact with third-party systems (e.g., to create, delete, or otherwise modify virtual machines implemented on such systems), it is necessary to generate commands using such private data. Further, users may need access to such private data in order to determine which modification actions to take on the third-party systems. The embodiments described herein use a controller that has access to a database of private data in order to secure that data, only exposing subsets of the data and/or information determined therefrom that is necessary to facilitate management of the third-party cloud, PaaS, or other type of computational system. This can include using the private data to determine user interface information therefrom (e.g., lists of virtual machines that satisfy a user-specified constraint) that can then be sent to a user without transmitting the full set of private data used to generate the user interface information. This can also include transmitting modification action commands that include only the private information necessary to implement the command, optionally over a specific controller-to-third party system communications link that has been secured in an elevated manner to provide enhanced protection to the private data that is part of the modification action command.

Another technical problem solved by the embodiments described herein is addressing the tension between different levels of user permissions required to command the effects of a modification action and to update databases to comport with the results of such modification actions. To address this issue, the embodiments described herein can obtain a first set of user credential data (or other permissions credential) to authorize a modification action to modify one or more database parameters associated with the modification action by determining that the first set of user credential data satisfies an update condition with respect to the database parameters. Such first credential data can be obtained, e.g., during review, modification, and/or approval of the modification action for use. Once this first credential information has been received and assessed against the update condition, it can then be executed by users to effect the changes in a cloud, PaaS, or other type of computing environment dictated by the modification action. Later, in order to execute the modification action, a user could provide a second set of user credential data (or other permissions credential) to authorize the execution of the modification action by determining that the second set of user credential data satisfies an update condition with respect to the command of the modification action. Credential information sufficient to cause the modification action to be executed (e.g., to result in the command being transmitted to the computing environment) could be insufficient to update the associated database parameters on its own.

Other technical improvements may also flow from these embodiments, and other technical problems may be solved. Thus, this statement of technical improvements is not limiting and instead constitutes examples of advantages that can be realized from the embodiments.

### VIII. Example Operations

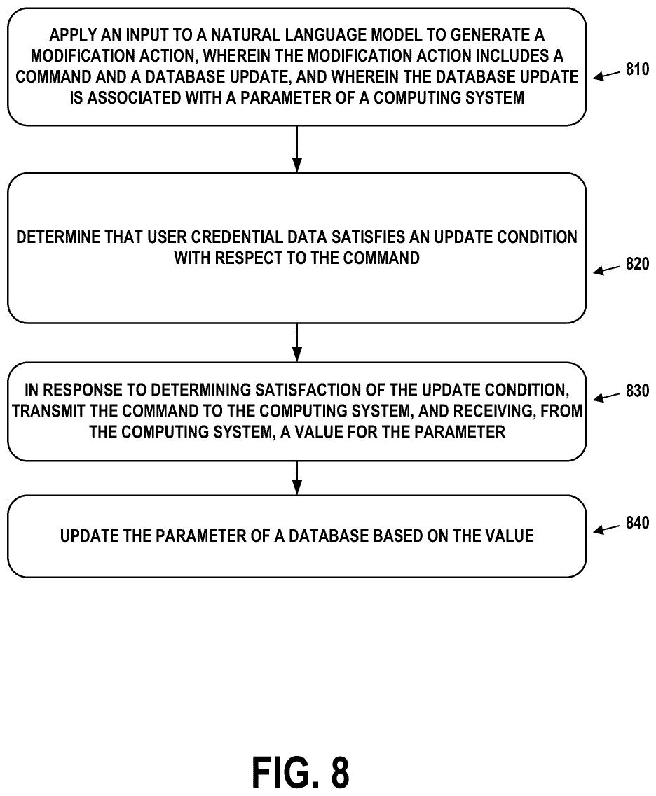

FIG. 8 is a flow chart illustrating an example embodiment. The process illustrated by FIG. 8 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 8 may be simplified by the removal of any one or more of the features shown therein. Further, these embodiments may be combined with features, aspects, and/or implementations of any of the previous figures or otherwise described herein.

The embodiments of FIG. 8 include applying an input to a natural language model to generate a modification action, wherein the modification action includes a command and a database update, and wherein the database update is associated with a parameter of a computing system (810). Applying the input to the natural language model to generate the modification action could include: (i) applying a first input to the natural language model to generate a list of names of potential modification actions that includes a name of the modification action; and (ii) applying a second input, that includes the name of the modification action, to the natural language model to generate the modification action. In such examples, the first input and the second input could both include text instructing the natural language model to produce output as though generated by a skilled developer.

The embodiments of FIG. 8 also include determining that user credential data satisfies an update condition with respect to the command (820). The embodiments of FIG. 8 additionally include, in response to determining satisfaction of the update condition, transmitting the command to the computing system, and receiving, from the computing system, a value for the parameter (830). The embodiments of FIG. 8 further include updating the parameter of a database based on the value (840).

The embodiments of FIG. 8 could include additional or alternative steps or elements. For example, the user credential data could be second user credential data, and the embodiments could additionally include: (i) obtaining, from a first user, first user credential data and an indication that the modification action is accepted; (ii) obtaining, from a second user, the second user credential data and an input to perform the modification action; and (iii) determining that the second user credential data satisfies the update condition with respect to the command, wherein transmitting the command to the computing system is performed in response to (a) obtaining the indication that the modification action is accepted and determining that the first user credential data satisfies the update condition with respect to the database update and (b) determining that the second user credential data satisfies the update condition with respect to the command. In such examples, the second user credential data might not satisfy the update condition with respect to the database update.

In some examples, the embodiments of FIG. 8 could include the computing system being a cloud computing environment, and applying the input to the natural language model, determining that the user credential data satisfies the update condition with respect to the command, transmitting the command to the computing system, and receiving the value for the parameter could be performed by a local computing system that is in communication with the cloud computing environment. In such examples, the command of the modification action could be to create, delete, or modify a virtual machine in the cloud computing environment, the database could include records relating to operation of one or more virtual machines in the cloud computing environment, and updating the parameter of a database based on the value could update one or more of the records to reflect creation, deletion, or modification of the virtual machine.

In some examples, the embodiments of FIG. 8 could additionally include (i) providing a virtual agent dialog to a user and obtaining user text from the user via the virtual agent dialog; and (ii) determining that the user text represents a user request to generate the modification action, wherein applying the input to the natural language model to generate the modification action is performed responsive to determining that the user text represents the user request to generate the modification action.

### IX. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
applying an input to a natural language model to generate a modification action, wherein the modification action includes a command and a database update, and wherein the database update is associated with a parameter of a computing system;
determining that user credential data satisfies an update condition with respect to the command;
in response to determining satisfaction of the update condition, transmitting the command to the computing system, and receiving, from the computing system, a value for the parameter; and
updating the parameter of a database based on the value.

2. The method of claim 1, wherein the user credential data is second user credential data, and wherein the method further comprises:
obtaining, from a first user, first user credential data and an indication that the modification action is accepted;
obtaining, from a second user, the second user credential data and a further input to perform the modification action; and
determining that the first user credential data satisfies a further update condition with respect to the database update,
wherein transmitting the command to the computing system is performed in response to (i) obtaining the indication that the modification action is accepted and determining that the first user credential data satisfies the further update condition with respect to the database update and (ii) determining that the second user credential data satisfies the update condition with respect to the command.

3. The method of claim 2, wherein the second user credential data does not satisfy the update condition with respect to the database update.

4. The method of claim 1, wherein applying the input to the natural language model to generate the modification action comprises:
applying a first input to the natural language model to generate a list of names of potential modification actions that includes a name of the modification action; and
applying a second input, that includes the name of the modification action, to the natural language model to generate the modification action.

5. The method of claim 4, wherein the first input and the second input both include text instructing the natural language model to produce output as though generated by a skilled developer.

6. The method of claim 1, wherein the computing system is a cloud computing environment, and wherein applying the input to the natural language model, determining that the user credential data satisfies the update condition with respect to the command, transmitting the command to the computing system, and receiving the value for the parameter are performed by a local computing system that is in communication with the cloud computing environment.

7. The method of claim 6, wherein the command of the modification action is to create, delete, or modify a virtual machine in the cloud computing environment, wherein the database includes records relating to operation of one or more virtual machines in the cloud computing environment, and wherein updating the parameter of a database based on the value updates one or more of the records to reflect creation, deletion, or modification of the virtual machine.

8. The method of claim 1, further comprising:
providing a virtual agent dialog to a user and obtaining user text from the user via the virtual agent dialog; and
determining that the user text represents a user request to generate the modification action, wherein applying the input to the natural language model to generate the modification action is performed responsive to determining that the user text represents the user request to generate the modification action.

9. A non-transitory computer-readable medium, having stored thereon program instructions that, upon execution by a controller comprising one or more processors, cause the controller to perform operations comprising:
applying an input to a natural language model to generate a modification action, wherein the modification action includes a command and a database update, and wherein the database update is associated with a parameter of a computing system;
determining that user credential data satisfies an update condition with respect to the command;
in response to determining satisfaction of the update condition, transmitting the command to the computing system, and receiving, from the computing system, a value for the parameter; and
updating the parameter of a database based on the value.

10. The non-transitory computer-readable medium of claim 9, wherein the user credential data is second user credential data, and wherein the operations further comprise:
obtaining, from a first user, first user credential data and an indication that the modification action is accepted;
obtaining, from a second user, the second user credential data and a further input to perform the modification action; and
determining that the first user credential data satisfies a further update condition with respect to the database update,
wherein transmitting the command to the computing system is performed in response to (i) obtaining the indication that the modification action is accepted and determining that the first user credential data satisfies the further update condition with respect to the database update and (ii) determining that the second user credential data satisfies the update condition with respect to the command.

11. The non-transitory computer-readable medium of claim 10, wherein the second user credential data does not satisfy the update condition with respect to the database update.

12. The non-transitory computer-readable medium of claim 9, wherein applying the input to the natural language model to generate the modification action comprises:
applying a first input to the natural language model to generate a list of names of potential modification actions that includes a name of the modification action; and
applying a second input, that includes the name of the modification action, to the natural language model to generate the modification action.

13. The non-transitory computer-readable medium of claim 12, wherein the first input and the second input both include text instructing the natural language model to produce output as though generated by a skilled developer.

14. The non-transitory computer-readable medium of claim 9, wherein the computing system is a cloud computing environment, and wherein applying the input to the natural language model, determining that the user credential data satisfies the update condition with respect to the command, transmitting the command to the computing system, and receiving the value for the parameter are performed by the one or more processors in communication with the cloud computing environment.

15. The non-transitory computer-readable medium of claim 14, wherein the command of the modification action is to create, delete, or modify a virtual machine in the cloud computing environment, wherein the database includes records relating to operation of one or more virtual machines in the cloud computing environment, and wherein updating the parameter of a database based on the value updates one or more of the records to reflect creation, deletion, or modification of the virtual machine.

16. The non-transitory computer-readable medium of claim 9, wherein the operations further comprise:
providing a virtual agent dialog to a user and obtaining user text from the user via the virtual agent dialog; and
determining that the user text represents a user request to generate the modification action, wherein applying the input to the natural language model to generate the modification action is performed responsive to determining that the user text represents the user request to generate the modification action.

17. A system comprising:
one or more processors; and
memory, containing program instructions that, upon execution by the one or more processors, cause the system to perform operations comprising:
applying an input to a natural language model to generate a modification action, wherein the modification action includes a command and a database update, and wherein the database update is associated with a parameter of a computing system;
determining that user credential data satisfies an update condition with respect to the command;
in response to determining satisfaction of the update condition, transmitting the command to the computing system, and receiving, from the computing system, a value for the parameter; and
updating the parameter of a database based on the value.

18. The system of claim 17, wherein the user credential data is second user credential data, and wherein the operations further comprise:
obtaining, from a first user, first user credential data and an indication that the modification action is accepted;
obtaining, from a second user, the second user credential data and a further input to perform the modification action; and
determining that the second user credential data satisfies a further update condition with respect to the database update,
wherein transmitting the command to the computing system is performed in response to (i) obtaining the indication that the modification action is accepted and determining that the first user credential data satisfies the further update condition with respect to the database update and (ii) determining that the second user credential data satisfies the update condition with respect to the command.

19. The system of claim 18, wherein the second user credential data does not satisfy the update condition with respect to the database update.

20. The system of claim 17, wherein the operations further comprise:
providing a virtual agent dialog to a user and obtaining user text from the user via the virtual agent dialog; and
determining that the user text represents a user request to generate the modification action, wherein applying the input to the natural language model to generate the modification action is performed responsive to determining that the user text represents the user request to generate the modification action.
